(19) United States
(12) Patent Application Publication
(10) Pub. No.: US 2024/0044677 A1
(43) Pub. Date: Feb. 8, 2024

(54) TEST CHAMBER AND METHOD FOR CONTROL

(71) Applicant: WEISS TECHNIK GMBH, Reiskirchen (DE)

(72) Inventors: Marc Loeffler, Balingen (DE); Juergen Nufer, Messstetten (DE)

(21) Appl. No.: 18/228,142

(22) Filed: Jul. 31, 2023

(30) Foreign Application Priority Data
Aug. 2, 2022 (EP) 22188386.1

(51) Int. Cl. G01D 11/24

(52) U.S. Cl. CPC G01D 11/24

(57) ABSTRACT

A test chamber for conditioning air (such as a climate chamber) and a method for controlling the test chamber. The chamber includes a temperature-insulated test space, (limited by walls closable using a door, and serving to received test material), a control device configured to control a function of the test chamber, and a temperature control device for controlling temperature of a test space that has at least one window. The temperature control device includes a cooling apparatus and a heating apparatus, and is configured to control the temperature within the test space from -40° C. to +180° C. The window of the test space is formed to have a shield device of the test chamber. The control device is configured to bring the shield device either into a first operating state or a second operating state. Here, in the first operational state the shield device establishes a window transmittance that is smaller (and/or a window absorbance that is larger) than that/those in the second operating state.

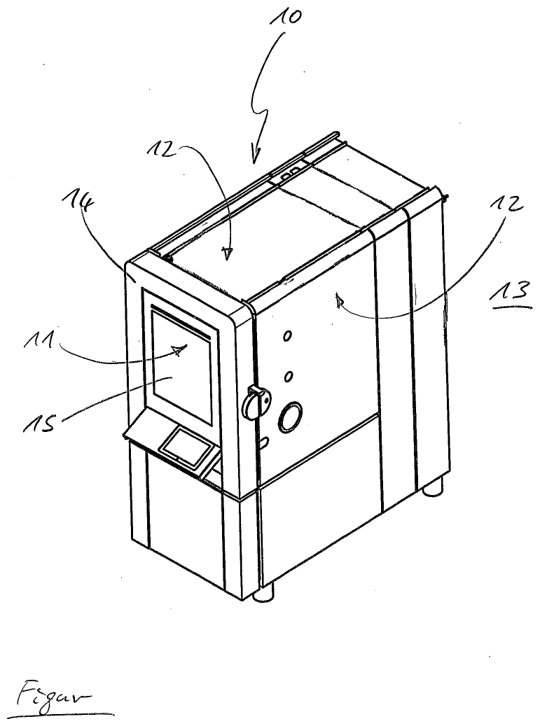

The invention relates to a test chamber for conditioning air, in particular a climate chamber or the like, and to a method for controlling a test chamber the test chamber comprising a temperature-insulated test space, which is limited with respect to an environment by walls, is closable using a door element and serves for receiving test material, a control device for controlling a function of the test chamber and a temperature control device for controlling the test space in temperature, the temperature control device having a cooling apparatus and a heating apparatus, a temperature ranging from −40° C. to +180° C. being able to be generated within the test space by means of the temperature control device, the test space having at least one window.

Test chambers are used for testing physical and/or chemical properties of objects, in particular devices. Thus, temperature test consoles or climate test consoles are known within which temperatures ranging from −40° C. to +180° C. can be set. In climate test consoles, desired climate conditions can be additionally set, to which the device and/or the test material is exposed over a defined period of time. Test chambers of this kind are commonly designed as a mobile apparatus, which is connected to a building merely via required supply lines and comprises all component groups required for controlling the test material in temperature. A temperature of a test space to receive the test material to be tested is commonly controlled in an air-circulation duct within the test space, in which heat exchangers for heating or cooling the air flowing through the air-circulation duct and/or the test space are disposed. Provided specific climate conditions and/or a defined relative air humidity is to be set, the test chamber can also have a device specifically for dehumidifying or humidifying the air in the test space.

When a temperature and/or climate changes within the test space, water can condensate on the test material, which can be desired depending on the test sequence. With tests of this kind, it is often important that a surface of the test material is thawed evenly and the surface is controlled evenly in temperature accordingly. A constant temperature and air humidity in the test space, and/or a corresponding homogeneous distribution, is thus of great importance for the quality of a test. It has shown, however, that a temperature in the test space can vary in an undesirable manner during a test interval and/or spatial differences in temperature can form in the test space and at the test material. This can lead to a surface of the test material only being partially thawed, for example. Among other things, these undesired effects can be caused by radiation energy falling on the test material through a window of the test space, for example. Depending on the position of the test chamber in a space of a building, sunlight or even heat radiation of other machines and installations in the building can fall on the test material via the window. Moreover, the test material itself, depending on the type of test material, can emit radiation energy, which can exit from the test space in a reverse manner. Nevertheless, it is desirable for the test space to have a window so that a user can monitor a state of the test chamber or of the test material in a simple manner.

The object of the invention is therefore to propose a test chamber and a method for controlling a test chamber, by means of both of which the temperature conditions and climate conditions can be generated particularly precisely and consistently.

This object is attained by a test chamber having the features of claim 1 and a method having the features of claim 10.

The test chamber for conditioning air, in particular a climate chamber or the like, comprises a temperature-insulated test space, which is limited with respect to an environment by walls, is closable using a door element and serves for receiving test material, a control device for controlling a function of the test chamber and a temperature control device for controlling the test space in temperature, the temperature control device having a cooling apparatus and a heating apparatus, a temperature ranging from −40° C. to +180° C., preferably −80° C. to +180° C., being able to be generated within the test space by means of the temperature control device, the test space having at least one window, the window being formed having a shield device of the test chamber, the control device being configured to bring the shield device either into a first operating state or into a second operating state, a transmission degree of the window being smaller in the first operating state and/or an absorption degree of the window being larger than in the second operating state by means of the shield device.

In the test chamber according to the invention, the temperature-insulated walls make it possible to mostly prevent a heat exchange with the environment of the test space. The door element, which serves for closing an opening of the test space, is also temperature-insulated. Via the door element, the test material can be inserted in the test space or be removed from the test space. The door element can tightly close the test space. The control device serves for controlling a function of the test chamber, for example to control the temperature control device, so a test interval having a defined test sequence can be automatically executed via cooling and/or heating the air in the test space by means of the control device. The control device can, for example, be a programmable logic control or a computer. Further, the test space has at least one window, via which a user can check the content of the test space.

According to the invention, it is intended for the window to be designed having a shield device of the test chamber. The shield device serves to prevent at least a partial, preferably entire, passing of electromagnetic radiation and/or heat radiation. This allows shielding the test material even better from influences of an environment, for example exposure to sunlight or heat radiation, meaning more constant test conditions are generated and even more precise tests can be carried out. Owing to the fact that the shield device can be brought into a first operating state, which causes the shielding, or, selectively, into a second operating state, it becomes possible to shield the test space non-permanently so that observing the test space would not be possible. This observation can be still be carried out during the second operating state. The first operating state differs from the second operating state in that a transmission degree of the window is smaller in the first operating state and/or an absorption degree of the window is larger than in the second operating state. In the second operating state of the shield device, an observation of the test space is consequently allowed and in the first operating state, the window is shielded so far that a test condition is not or only insignificantly impacted via the window. The control device controls the shield device, whereby a controlled shielding of the test space is possible. Overall, it is also possible to save cooling energy and/or heating energy and thus to lower a power consumption of the test chamber.

By means of the shield device, electromagnetic radiation, preferably heat radiation, UV radiation, visible light and/or IR radiation, can be shielded in the first operating state. Aside from the heat radiation, ultraviolet radiation and visible light and/or infrared radiation can influence a test in an undesired manner, depending on the quality of the test material. The shield device can thus be designed such that this radiation is also shielded from the first operating state by means of the shield device and thus cannot pass through the window. In the second operating state, this radiation or portions thereof can reach the test material or the test space via the window.

Consequently, the window can be non-transparent in the first operating state and be transparent in the second operating state. Thus, it is easy for a user to identify a state of the shield device or the first operating state or the second operating state without difficulty.

The shield device can have a shield apparatus, the shield apparatus being made of a glass or a film having thermochromic, electrochromic and/or photochromic properties, the shield apparatus being able to cover a window surface of the window. The shield apparatus is preferably designed in such a manner that the window surface of the window is entirely covered. Generally, it would also be possible to intend only a partial covering of the window surface of the window and to exclude an area of the window surface, in which no shield device is formed or disposed on the window. The shield apparatus can be made particularly easily of a glass or a film, which is designed having thermochromic, electrochromic and/or photochromic properties. Generally, it is thus also possible to design the shield apparatus having several glasses or films, which, depending on the requirements, can have different properties and thus different effects of a shielding of different radiation. Undesired physical influences can thus be shielded to suit individual requirements. Further, it is also possible to indirectly influence an effect of a shielding via a test sequence, e.g., via a temperature in the test space.

The glass or film can be made using liquid crystal technology and is electrically switchable in the first operating state or in the second operating state. For this purpose, it can be intended for the glass or the film to be affixed on a pane of the window, preferably on a pane oriented towards an environment. For instance, the first and the second operating state can be easily generated by reversing the pole of a voltage. Heat radiation falling on the window can then be reflected and/or absorbed in the second operating state.

The window can be received in the door element or a wall, the window having outer panes and at least one intermediate inner pane. The window can be what is known as an insulating glass window or have a multi-pane insulating glass. Furthermore, glass panes of the window can also be provided with a coating. Preferably, the shield device is affixed to an outer pane of the window. The shield device can be disposed between the one outer pane and the intermediate pane. Consequently, the shield device can then be disposed within the window.

The control device can have an operating apparatus having a screen and operating elements and have a measuring device for determining a temperature and/or air humidity. The operating apparatus can be configured for manually operating the control device. Via the screen of the operating apparatus, up-to-date measured values or selected operating state can be indicated, for example. The operating elements can be formed by switches or a touch-sensitive screen. The measuring device can measure a temperature and/or air humidity within the test space or directly at the test material.

The test chamber can have a humidifying device for setting an air humidity ranging from 10% to 98% relative air humidity within the test space. The humidifying device can then be advantageously used together with the temperature control device to form certain climate conditions in the test space.

The cooling apparatus can be designed having a cooling cycle having a refrigerant, a heat exchanger, which is disposed in the test space, a compactor, a condenser and an expansion element. Consequently, the cooling apparatus can be designed having a compression refrigeration machine.

In the method according to the invention for controlling a test chamber for conditioning air, in particular a climate chamber or the like, test material is disposed in a temperature-insulated test space of the test chamber, the test space being limited with respect to an environment by walls and being closable using a door element, a control device of the test chamber controlling a function of the test chamber, a temperature control device of the test chamber controlling the test space in temperature, a temperature ranging from −40° C. to +180° C., preferably −80° C. to +180° C., being generated within the test space by means of a cooling apparatus and a heating apparatus of the temperature control device, the test space having at least one window, the control device bringing a shield device of the window either into a first operating state or into a second operating state, a transmission degree of the window being smaller in the first operating state and/or an absorption degree of the window being larger than in the second operating state by means of the shield device. Reference is made to the description of advantages of the device regarding the advantages of the method according to the invention.

A switch between the first operating state and the second operating state can take place by means of an operating apparatus of the control device. For instance, it is possible for a user to carry out the switch between the corresponding operating states by actuating an operating element. The user can deactivate the shield device and/or its shielding effect during the test sequence, e.g., for observation purposes. After the observation, the shielding effect of the shield device can be reactivated, meaning the test sequence can be continued mostly uninterrupted or unaffected by radiation from an environment.

The switch between the first operating state to the second operating state and/or a locking or unlocking of the door element can take place by means of the control device after an identification of the user by means of the operating apparatus. The identification of the user by means of the operating apparatus ensures that only authorized users can open and lock the door element as well as switch between the first operating state and the second operating state. The control device can also be configured in such a manner that only authorized users can carry out changes at the control device. Thus, it can be mostly ensured that only authorized users can interfere in a test sequence. The function of the identification, however, can also be used for logging, i.e., the control device can be used for recording which user can interfere in the test sequence.

The first operating state can be chosen as a base state, a switch to the second operating state being able to take place upon request. Accordingly, the control device can be configured such that the shield device is always in the first operating state first. Upon request, for example via an operating apparatus of the control device, a switch to the second operating state can take place. It is thus ensured that the window and/or the test space is shielded as much as possible using the shield device in the base state. An accidental execution of the test sequence during the second operating state can thus be prevented.

The control device can switch from the second operating state to the first operating state after an amount of time stored in the control device has expired. The amount of time can be pre-specified or set by a preset time in the control device or in the manner of a clock timer. Thus, it is possible that an amount of time of the second operating state is registered by the control device when a switch takes place in the second operating state, and the switch to the first operating state takes place after the stored amount of time or the preset time has expired. The amount of time can be, for example, 30 seconds, one minute, two minutes, five minutes or the like. Consequently, it can be ensured that the shield device is not in the second operating state for too long or a user does not accidentally switch to the second operating state or misses switching from the second operating state to the first operating state.

The control device can switch on a test-space lighting of the test chamber only during a duration of the second operating state. When the second operating state is used for observing the test sequence, it can be advantageous for the test space to be illuminated during the observation. Since a test-space lighting most assuredly emits radiation energy which could influence a test sequence, the test-space lighting can be used or operated in conjunction with the second operating state. This makes operating the test chamber even easier.

The control device can switch on a window-frame heating apparatus of the window and/or a window-area heating apparatus of a window area of the window only during a duration of the second operating state. In particular with regard to thawing a window surface in the scope of a test sequence, it is advantageous if the window surface is thawed by means of a window-frame heating apparatus and/or the window-area heating apparatus in order to be able to observe the test sequence unhindered. Since thawing is only required when the second operating state is switched on, this function can be switched in conjunction with the second operating state. As in particular a window-frame heating apparatus and a window-area heating apparatus emit heat energy and/or heat radiation, a test sequence can be carried out even more precisely if this function and/or apparatuses are only used during the test sequence when actually necessary.

Further advantageous embodiments of the method are derived from the description of features of the dependent claims referring to device claim 1.

In the following, a preferred embodiment of the invention is described in more detail with reference to the FIGURE.

The FIGURE shows a perspective view of a test chamber 10 having a temperature control device (not shown) for controlling a test space 11 of test chamber 10 in temperature. Test space 11 is limited by walls 12 with respect to an environment 13 and is closed using a door element 14. A window 15 of test space 11 is disposed in door element 14. Window 15 is formed having a shield device (not shown). A control device (also not shown) of test chamber 10 is configured to bring the shield device either to a first operating state or to a second operating state, a transmission degree of window 15 being smaller in the first operating state and/or an absorption degree of window 15 being larger in the second operating state by means of the shield device. Consequently, radiation energy which could enter test space 11 from environment 13 via window 15 can be shielded in the first operating state by means of the shield device. Vice versa, radiation energy which can enter environment 13 from test space 11 via window 15 can also be shielded. In the second operating state, a shielding effect of the shield device can be deactivated insofar that this radiation energy can pass window 15 at least partially. It is then possible for a user to observe a test sequence in test space 11.

1. A test chamber for conditioning air the test chamber comprising:
a temperature-insulated test space, which is limited with respect to an environment by walls has at least one window, and is closable using a door element, the test space configured to receive test material,
a control device configured to control a function of the test chamber, and
a temperature control device configured to control temperature of the test space from at least −40° C. to +180° C. in temperature, the temperature control device having a cooling apparatus and a heating apparatus,
wherein the at least one window is formed having a shield device of the test chamber,
wherein the control device is configured to bring the shield device either into a first operating state or into a second operating state,
wherein the shield device is configured to generate a transmission degree of the at least one window that is smaller in the first operating state than in the second operating state and/or an absorption degree of the at least one window that is larger in the first operating state than in the second operating state.

2. The test chamber according to claim 1,
wherein the shield device is configured to shield electromagnetic radiation in the first operating state.

3. The test chamber according to claim 1
wherein the at least one window is non-transparent in the first operating state and transparent in the second operating state.

4. The test chamber according to claim 1, wherein
the shield device has a shield apparatus that includes a glass or a film having thermochromic, electrochromic and/or photochromic properties, the shield apparatus covering a window surface of the at least one window.

5. The test chamber according to claim 4,
wherein the glass or the film includes a liquid crystal and is electrically switchable to the first operating state or to the second operating state.

6. The test chamber according to claim 1, wherein
the at least one window is disposed in the door element or a wall, the at least one window having outer panes and at least one intermediate inner pane.

7. The test chamber according to claim 1, wherein
the control device has an operating apparatus that includes a screen and operating elements, and has a measuring device configured to determine a temperature and/or air humidity.

8. The test chamber according to claim 1, wherein
the test chamber has a humidifying device configured to set relative air humidity ranging from 10% to 98% within the test space.

9. The test chamber according to claim 1, wherein
the cooling apparatus is configured to have a cooling cycle defined in part by a refrigerant, a heat exchanger disposed in the test space, a compactor, a condenser, and an expansion element.

10. A method for controlling a test chamber configured to control air and having a test space, which is limited with respect to an environment by walls, has at least one window, and is closable with a door element, the method comprising:
operating a temperature control device, of the test chamber, that has a cooling apparatus and a heating apparatus and that is configured to vary a temperature of the test space at least from −40° C. to +180° C.
operating a control device configured to control a function of the test chamber to bring a shield device of the window in either a first operating state or a second operating state,
wherein said shield device is configured to cause a transmittance of the at least one window be smaller in the first operating state than in the second operating state and/or an absorbance of the at least one window be larger in the first operating state than in the second operating state.

11. The method according to claim 10, comprising:
switching the shield device between the first operating state and the second operating state with the use of an operating apparatus of the control device.

12. The method according to claim 10 comprising:
establishing identity of a user with an operating apparatus of the of the control device to determine whether the user is an authorized user; and
switching the shield device between the first operating state and the second operating state and/or unlocking or locking the door element with the use of the control device after the user has been identified as an authorized user.

13. The method according to claim 10, comprising:
choosing the first operating state as a base state and switching to the second operating state upon request.

14. The method according to claim 10, comprising:
switching the control device from the second operating state to the first operating state after time pre-set in the control device has lapsed.

15. The method according to claim 10, wherein the test chamber includes a test-space lighting, and further comprising:
switching said test-space lighting with the control device only during a duration of the second operating state.

16. The method according to claim 10, wherein the at least one window includes a window-frame heating apparatus and/or the at least one window includes a window-area heating apparatus, and comprising:
switching said window-frame heating apparatus and/or said window-area heating apparatus only during a duration of the second operating state.

17. The test chamber according to claim 1, wherein the temperature control device is configured to control the temperature of the test space from at least −80° C. to +180° C.
